(19) United States
(12) Patent Application Publication
(10) Pub. No.: US 2010/0231581 A1
(43) Pub. Date: Sep. 16, 2010

(54) Presentation of Data Utilizing a Fixed Center Viewpoint

(75) Inventor: James Richard Shroads, Denver, CO (US)

Correspondence Address: Schubert Law Group PLLC, 6013 CANNON MOUNTAIN DRIVE, S14, AUSTIN, TX, 78749, US

(73) Assignee: JAR ENTERPRISES INC., Denver, CO (US)

(21) Appl. No.: 12/400,906

(22) Filed: Mar. 10, 2009

(51) Int. Cl. G06T 15/00; G06T 11/20

(52) U.S. Cl. 345/419; 345/441

(57) ABSTRACT

Generally speaking, systems, methods and computer program products for presenting data based on a fixed center viewpoint are disclosed. Embodiments may include receiving a request for an informational surround data shell that depicts a position for one or more objects relative to a celestial body from a point of view at a single fixed center viewpoint and determining a radial distance from the center viewpoint. Embodiments may include generating a data shell based on the determined radial distance and, for each informational surround, generating one or more objects each at the radial distance for rendering in the generated data shell. Embodiments may include generating the informational surround data shell from the point of view of the center viewpoint by rendering the generated objects within the data shell based on their position and transmitting the generated informational surround data shell for presentation to the user.

### FIELD OF THE INVENTION

The present invention relates to a data presentation system, and in particular, to a data processing system for the presentation of data to a user utilizing a fixed center viewpoint.

### BACKGROUND

Representation of geographic information, particularly geographic information that is global in scope, has presented problems for centuries. The display of geospatial information, which includes any data that identifies the geographic location of features and boundaries on the Earth, such as natural or man-made features, has presented similar issues. Presently, many different applications utilize mapping of the position of the location, quantity, and movement of objects or locations in the form of multi-faceted maps and aerial photographs. These maps typically represent multiple views looking directly down onto the surface. These maps become distorted or split into sections so that they may be printed flat. The systems are plagued, however, with a variety of problems such as distortion, inaccuracy, and complexity, problems which are exacerbated as the scope of any resulting maps increases towards a global view.

Many types of maps have been developed to represent three-dimensional space in the two-dimensions of a physical map or computer screen. World maps typically use a projection to convert a three-dimensional globe onto a two-dimensional planar map. A map projection can be considered to be any method of representing the surface of a sphere (or other shape) on a plane. These projections, however, inevitably result in some level of distortion in order to complete the projection. Different map projections are designed to help preserve one or more properties such as area, shape, direction, bearing, distance, or scale, and each known projection is a compromise of some of these properties in favor of others.

One well-known type of projection is the Mercator projection. The Mercator projection is a cylindrical map projection that preserves lines of constant course, or rhumb lines, as straight segments, making it a popular projection for nautical purposes. The Mercator projection, however, also distorts the size and shape of large objects and the distortion increases for objects the closer they are to the poles. For a global map, the Mercator projection results in significant distortion of Northern and Southern objects, such as Greenland and Antarctica.

Another type of projection is the gnomonic projection, which has the benefit of displaying great circle routes as straight lines. The gnomonic projection is created by projecting, with respect to the center of the Earth, the Earth's surface onto a tangent plane that touches the Earth's surface at one point (such as a pole). The gnomonic projection results in minimum distortion where the Earth's surface touches the tangent plane and increasing distortion as the distance from the tangent point increases. The gnomonic projection also only can depict one hemisphere on a single map and thus can only show half of the surface area of the Earth because of the physical nature of the projection.

The existing systems result in levels of distortion that are unacceptable for many purposes because, due to the fact that objects are actually located on a spherical shape, objects become distorted as the view widens toward the horizon. One other way that existing art compensates for this distortion is to split the sphere along longitudinal lines into curved sections that only touch at the equator so that a map of information can lay flat while retaining the correct scale at all points. The resultant map, however, results in physical gaps in the map as well as a required intellectual effort to understand that opposing sides of the curved sections do come together and touch in reality.

Aerial photographic systems, like maps, also view objects from a point of view outside or above the Earth and thus present maps with the same point of view. Applications such as Google Inc.'s Google Earth™ mapping service utilize these types of aerial photographic maps to provide maps of particular locations to users. Aerial photographs, however, can provide distorted views as the only location without distortion is the location directly beneath the device taking the aerial photographs. Any other locations than that directly below the device have distortion resulting from the curvature of the earth, and such distortion increases as the distance from the location directly beneath increases. The “viewing” position for any user-requested location is a position in three-dimensional space above the surface of the earth at that requested location, requiring new computations whenever the viewed location is changed as the viewing position will also move in three-dimensional space.

### SUMMARY

The problems identified above are in large part addressed by systems, methods and computer program products for presenting data based on a fixed center viewpoint. Embodiments of a computer-implemented method to facilitate presentation of data from a fixed center viewpoint may include receiving a request for an informational surround (IS) data shell to be presented to a user from a point of view at a single fixed center viewpoint inside of a celestial body, the requested IS data shell comprising one or more IS's, each of the one or more IS's comprising one or more objects to be presented to the user within the IS data shell. The method may also include determining a radial distance from the center viewpoint of the celestial body for the IS data shell and generating a data shell from a point of view of the center viewpoint based on the determined radial distance. The method may also include, for each of the one or more requested IS's, generating one or more associated objects, each at the radial distance from the center viewpoint, for rendering in the generated data shell based on the position of each object relative to the celestial body. The method may also include generating the IS data shell from the point of view of the center viewpoint by rendering each of the one or more generated objects within the generated data shell based on their position relative to the celestial body, the IS data shell comprising both the generated data shell and the one or more generated objects rendered within the generated data shell based on their position relative to the celestial body. The method may also include transmitting the generated IS data shell for presentation to the user.

Another embodiment provides a computer program product comprising a computer-useable medium having a computer readable program that, when executed on a computer, causes the computer to perform a series of operations for facilitating presentation of data based on a fixed center viewpoint. The series of operations generally includes receiving a request for an IS data shell to be presented to a user from a point of view at a single fixed center viewpoint inside of a celestial body, the requested IS data shell comprising one or more IS's, each of the one or more IS's comprising one or more objects to be presented to the user within the IS data shell. The series of operations may also include determining a radial distance from the center viewpoint of the celestial body for the IS data shell and generating a data shell from a point of view of the center viewpoint based on the determined radial distance. The series of operations may also include, for each of the one or more requested IS's, generating one or more associated objects, each at the radial distance from the center viewpoint, for rendering in the generated data shell based on the position of each object relative to the celestial body. The series of operations may also include generating the IS data shell from the point of view of the center viewpoint by rendering each of the one or more generated objects within the generated data shell based on their position relative to the celestial body, the IS data shell comprising both the generated data shell and the one or more generated objects rendered within the generated data shell based on their position relative to the celestial body. The series of operations may also include transmitting the generated IS data shell for presentation to the user.

A further embodiment provides a data processing system having a machine-accessible medium storing a plurality of program modules. Embodiments may include a surround generator module to generate an IS data shell from a point of view of a single fixed center viewpoint of a celestial body. The surround generator module may include a data shell generator to generate a data shell from the point of view of the center viewpoint based on a determined radial distance from the center viewpoint and an IS generator to generate objects associated with a requested IS, each at the determined radial distance from the center viewpoint, for rendering in the generated data shell based on the position of each object relative to the celestial body. The surround generator module may also include a surround combination module to generate an IS data shell by rendering generated objects, each associated with a requested IS, within the generated data shell based on their position relative to the celestial body. Embodiments may include a user interface module, in communication with the surround generator module, to receive input from users and to provide output to users. Embodiments of the user interface module may include a user input analysis module to receive requests to view an IS data shell and to receive inputs from a user input device. Embodiments of the user interface module may also include a presentation module to transmit to a user output device the generated IS data shell for presentation of the generated IS data shell to a user.

A further embodiment provides a system for presenting data to a user. The system may include a data processing system having a machine-accessible medium storing a plurality of program modules. Embodiments may include a surround generator module to generate an IS data shell from a point of view of a single fixed center viewpoint of a celestial body. The surround generator module may include a data shell generator to generate a data shell from the point of view of the center viewpoint based on a determined radial distance from the center viewpoint and an IS generator to generate objects associated with a requested IS, each at the determined radial distance from the center viewpoint, for rendering in the generated data shell based on the position of each object relative to the celestial body. The surround generator module may also include a surround combination module to generate an IS data shell by rendering generated objects, each associated with a requested IS, within the generated data shell based on their position relative to the celestial body. Embodiments may include a user interface module, in communication with the surround generator module, to communicate with users via a user interface device. Embodiments may also include a user interface device in communication with the data processing system to present IS data shells to users. The user interface device may include a surround conversion module to convert a received IS data shell into output commands and a user output device to present the received IS data shell to a user based on the output commands.

### BRIEF DESCRIPTION OF THE SEVERAL VIEWS OF THE DRAWINGS

Aspects of certain embodiments will become apparent upon reading the following detailed description and upon reference to the accompanying drawings in which like references may indicate similar elements:

FIG. 1 depicts a perspective, partial view from an external point of view of an object and an informational surround (IS) coordinate system with a center viewpoint to describe the object according to some embodiments;

FIG. 2 depicts a cut-away, perspective view of the object and IS coordinate system of FIG. 1 from the internal point of view of the center viewpoint according to some embodiments;

FIG. 3 depicts a cut-away, perspective view of the IS coordinate system of FIG. 1 and various cities on the surface of the Earth from the internal point of view of the center viewpoint according to some embodiments;

FIGS. 4A-4B depict a side and top view, respectively, from an external point of view of latitude and longitude lines of a celestial body that may represented by the IS coordinate system according to some embodiments;

FIG. 5 depicts a partial upward looking view from the internal center viewpoint of latitude and longitude lines of the celestial body of FIG. 4A and a typical focal view according to some embodiments;

FIG. 6 depicts a partial view from the internal center viewpoint of latitude and longitude lines of a celestial body and a typical focal view according to some embodiments;

FIG. 7 depicts example fixed objects viewed from the center viewpoint suitable for rendering on an IS data shell;

FIG. 8 depicts a center viewpoint and a radial distance according to some embodiments;

FIG. 9 depicts a schematic view of a user using virtual reality goggles to view an IS data shell according to some embodiments;

FIG. 10 depicts a partial cut-away side view of a user using an enclosed IS data shell according to some embodiments;

FIG. 11 depicts a schematic view of a user using a surround display to view an IS data shell according to some embodiments;

FIG. 12 depicts an IS system with an IS manager, an associated IS database, a network, one or more resources, and a user interface device according to some embodiments;

FIG. 13 depicts a block diagram of one embodiment of a computer system suitable for use as a component of the IS system, such as an IS viewing system or a data processing system to execute the IS manager;

FIG. 14 depicts a conceptual illustration of software components of an IS manager according to some embodiments;

FIG. 15 depicts an example of a flow chart for presenting a generated IS data shell to a user according to some embodiments; and

FIG. 16 depicts an example of a flow chart for generating an IS data shell depicting one or more objects according to some embodiments.

### DETAILED DESCRIPTION

The following is a detailed description of example embodiments depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

### Definitions

A number of definitions useful to understanding the disclosed embodiments are included herein. As used herein, the following terms have the described meanings:

“Data Shell”—a presented spherical representation, having a specified radial distance from a fixed center viewpoint and from the point of view of the fixed center viewpoint, for presentation of one or more informational surrounds to a user.

“Informational Surrounds”, also known as “IS's”—a set of data at a specified radial distance from a center viewpoint for presentation as objects within a data shell.

“Informational Surround Data Shell”—a presented combination of a data shell and one or more informational surrounds that each include one or more objects rendered within based on their position relative to a celestial body. The informational surround data shell is presented from the point of view of the fixed center viewpoint and each depicted object is at the radial distance.

“Radial distance”—a distance or range of distances from the fixed center viewpoint.

“Rendering”—the presentation of one or more informational surrounds and their constituent objects within a data shell such that patterns, movements, volumes, etc. are accurately shown. When multiple informational surrounds are rendered simultaneously they may overlay each other so that relationships between the objects of each informational surround may be more easily seen.

“Presenting”—providing an informational surround data shell having one or more informational surrounds (with their rendered objects) within a data shell such that the underlying data may be sensed by a user, such as by a user viewing a rendered informational surround data shell with virtual reality devices such as helmets or goggles.

“Data”—any type of information that may be represented by an object in an informational surround data shell, including but not limited to tangible and intangible items, entities, measurements, individuals, numeric values

“Object”—the representation of data within a data shell as presented to a user. Objects may either be fixed objects or mobile objects.

“Fixed center viewpoint”—the virtual center of informational surround data shells, informational surrounds, and data shells. In many embodiments, the fixed center viewpoint will be the center of a celestial body such as Earth. Every object presented on an informational surround data shell, and the entire surface of the data shell, may be viewed from the fixed center viewpoint. One of ordinary skill in the art will recognize that, while a fixed center viewpoint at the precise geographic center of a celestial body will provide the most accuracy, other locations substantially near the geographic center of the celestial body may also be used with an according decrease in accuracy.

“Field of view”—the cone of vision of the informational surround data shell from the point of view of the fixed center viewpoint.

“Focal view”—the view from the center point of the informational surround data shell. In many embodiments, the focal view is a cone of 30 degrees of diameter or less to correspond to the natural, focus field of vision for humans, though larger focal views are also envisioned.

“Focal map”—a two-dimensional representation of all or part of a three-dimensional informational surround data shell such as a printed map or conventional computer screen display. By flattening a portion of the concave surface of an informational surround data shell, some distortion is introduced, but distortions may typically be acceptable if the size of the focal map is kept to approximately 30 degrees of diameter of field of vision or less. This field of vision roughly corresponds with the natural field of focused, non-peripheral vision of a typical human.

“IS coordinate system”—a coordinate system centered at the fixed center viewpoint of a celestial body that describes the physical position of an object in three-dimensional space relative to the celestial body. In some embodiments, an IS coordinate system may include the variables of radial distance, angle from a reference meridian, and angle from an equator, though other sets of variables may also be used.

“Viewing direction”—the virtual line in three-dimensional space from the fixed center viewpoint to an object. In some embodiments, viewing direction may be specified by an angle from the equator and the angle relative to a reference meridian.

### Overview

Generally speaking, systems, methods and computer program products for presenting data based on a fixed center viewpoint are disclosed. Embodiments of a computer-implemented method may include receiving a request for an informational surround (IS) data shell to be presented to a user from a point of view at a single fixed center viewpoint inside of a celestial body, the requested IS data shell comprising one or more informational surrounds (IS's), each of the one or more IS's comprising one or more objects to be presented to the user within the IS data shell and determining a radial distance from the center viewpoint of the celestial body for the IS data shell. The method may also include generating a data shell from a point of view of the center viewpoint based on the determined radial distance and, for each of the one or more requested IS's, generating one or more associated objects, each at the radial distance from the center viewpoint, for rendering in the generated data shell based on the position of each object relative to the celestial body. The method may also include generating the IS data shell from the point of view of the center viewpoint by rendering each of the one or more generated objects within the generated data shell based on their position relative to the celestial body, the IS data shell comprising both the generated data shell and the one or more generated objects rendered within the generated data shell based on their position relative to the celestial body and transmitting the generated IS data shell for presentation to the user.

The system and methodology of the depicted embodiments allow for effective and efficient rendering and presentation of IS data shells based on a single fixed center viewpoint. As will be described in more detail subsequently, the disclosed embodiments present to a user a variety of objects that are at a specified radial distance (which may be a single distance or a range of distances) from the center of a celestial body such as Earth from a viewpoint coincident with the center of the celestial body. Objects that are at the radial distance may be included on the IS data shell and may be positioned based on their position relative to the celestial body. By presenting an IS data shell of objects at a radial distance from the perspective of a center viewpoint, users may view objects in a novel fashion that also has the effect of increasing accuracy and reducing distortions.

Distortion between objects rendered as part of an IS data shell may be minimized or substantially eliminated in the disclosed embodiments as each small area of the IS data shell is effectively perpendicular to the viewer (who is virtually positioned at the center of the celestial body), resulting in minimal distortion when compared to existing map projections as well as aerial photography or mapping. The single center viewpoint (also called the informational surround, or IS, position) of the disclosed embodiments provides for substantially nonexistent distortion for all objects on the resultant shell since each is viewed from a constant viewpoint, in contrast with existing methodologies that utilize a multitude of outside viewpoints looking inward towards the Earth where objects to the side of the primary viewpoint become distorted and out-of-scale until they are lost from view over the horizon. Moreover, distances between objects on the IS data shell are in scale relative to one another, providing for improved ability to analyze objects and their relationships. By providing an IS data shell with accurate distances and minimal distortion, individuals may more effectively analyze objects and the relationship between objects to ascertain trends, current status information, historical results, or any other type of data. The reduction of distortion and the accuracy of straight line distances also effectively reduce variables for consideration, resulting in more intuitive, effective and efficient analysis.

While presentation of data as part of an IS data shell provides the lowest levels of distortion and the most accuracy, users may also view data from the IS data shell reduced to a two-dimensional surface such as a printed map. The distortion may be relatively minimized as long as the user's field of view at a particular time extends in a cone of approximately 30 degrees or less in diameter (i.e., a focal map), though larger fields of view with somewhat higher distortions are certainly envisioned and encompassed within the disclosed embodiments.

Users may utilize any type of technology to view an IS data shell, including virtual reality-based or other immersive types of systems. In many embodiments where a full view at one particular time is not possible, a user may instead view only a portion of the IS data shell based on the user's desired viewing direction and a field of view centered about the desired direction. In this fashion, a user may view a relatively narrow cone (30 degrees across or less according to some embodiments) of the IS data shell at once with minimal distortion. Users may then input a new desired viewing direction (such as by turning their head while using virtual reality goggles) and a new section of the IS data shell may then be displayed to them. In this fashion, users may conveniently view various portions of an IS data shell in a fashion that facilitates accurate analysis of the information on the map.

### Informational Surround (IS) Coordinate System

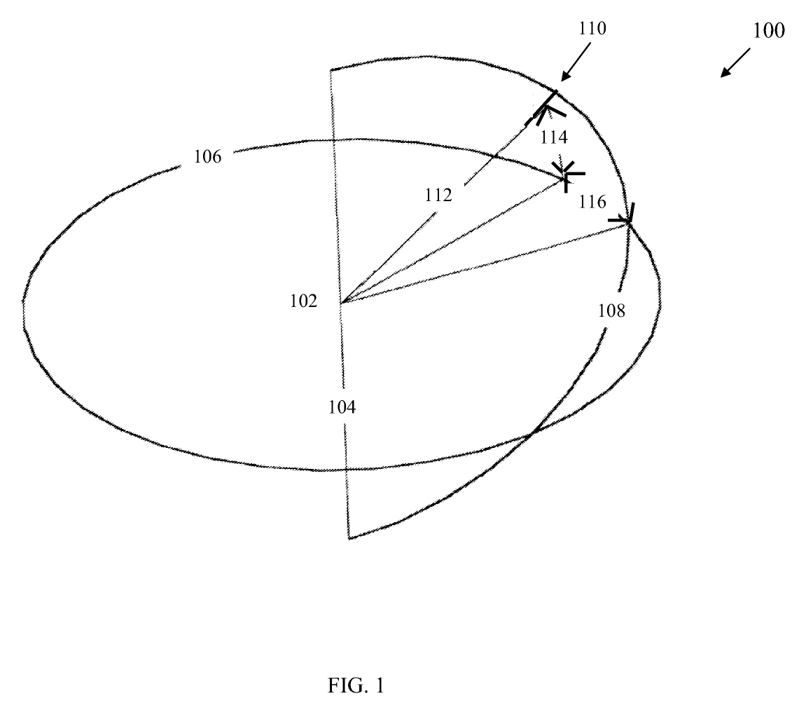

Turning now to the drawings, FIG. 1 depicts a perspective, partial view from an external point of view of an object and an informational surround (IS) coordinate system with a center viewpoint to describe the object according to some embodiments. The disclosed IS coordinate system 100 includes a single center viewpoint 102 which provides the reference point for which any objects 110 can be described by the IS coordinate system 100 and the spherical relationships utilized in that description. The IS coordinate system 100 may thus be used to describe the physical position of an object 110 relative to the celestial body represented by the IS coordinate system 100. The center viewpoint 102 may be located midway along a central axis 104 of a celestial body. In the depicted embodiment, the IS coordinate system 100 also includes an equator 106 and a reference meridian 108 which cross each other perpendicularly at two points. The equator 106 may be centered about and perpendicular to the central axis 104 while the reference meridian 108 may be parallel with the central axis 104, which also bisects the circle formed by the reference meridian 108. The IS coordinate system 100 also includes a specified radial distance 112 from the center viewpoint 102. An object 110 at the radial distance 112 may therefore be accurately described within the IS coordinate system 100 by two angles, the angle from the equator 114 and the angle from the reference meridian 116, which together form the IS position of the object 110.

The disclosed IS coordinate system 100 facilitates conversion of a location of an object 110 in three-dimensional space to an informational surround position (IS position) that may be rendered in an IS (as will be described subsequently) or represented on a two-dimensional map (which may advantageously have less than a 30 degree field of view to minimize distortions). With a specified radial distance 112 from the center viewpoint 102, the three-dimensional space formed by the IS coordinate system 100 is a sphere, making the coordinate system particularly appropriate for Earth-based renderings or renderings of other planetary bodies. While the Earth is not an exact sphere and is instead an oblate spheroid, the differences in shape between the actual Earth and a perfect sphere are small enough that any distortion in the resultant rendered IS data shell is substantially non-existent for describing the position of objects at a radial distance near the surface of the Earth as the distortion of the Earth as compared to a perfect sphere is approximately 0.4%. While much of the discussion herein will be described in reference to the Earth for matters of clarity, one of ordinary skill in the art will recognize that the disclosed methodology would also be applicable to other sphere-like objects, such as other planets, stars, or other celestial bodies that are substantially spherical in shape, as well as micro-sized objects such as atoms.

The single center viewpoint 102 may be typically positioned at the geometric center of a celestial body such as the Earth and forms the center of the sphere of the IS coordinate system 100. Each object 110 may be viewed from the point-of-view of the center viewpoint 102 and looking outward, in contrast to conventional systems which typically are required to have a multitude of viewpoints outside the sphere and looking inward. By viewing objects from a center viewpoint 102, each object may be viewed directly and without distortion. Outside viewpoints cannot “see” the entire surface of the sphere from a single position and thus have a non-distorted view of objects directly between the point of view and the center of the sphere, while any objects viewed off of this axis become increasingly distorted and out-of-scale until they are lost from view over the horizon.

The central axis 104, equator 106, and reference meridian 108 together help form a spherical representation of positions in three-dimensional space, as described previously. The central axis 104 may be, in some embodiments, a line from the North Pole to the South Pole of the Earth that is approximately coincident with the axis of rotation of the Earth. The equator 106 according to some embodiments may be positioned midway along the central axis 104 and be a circle with a radius equal to the radial distance 112 centered about that axis. The reference meridian 108 may be any meridian perpendicular to the equator. In some embodiments where the celestial body is the Earth, the reference meridian 108 may be the Prime Meridian, a meridian chosen by geographers as a reference line that passes through Greenwich, England and that has a longitude of zero degrees.

While an IS coordinate system 100 based on a celestial body's central axis 104 and equator 106 is depicted here and used throughout, one of ordinary skill in the art will recognize that other sets of central axes 104, equators 106, and reference meridians 108 may be used, such as a central axis 104 that is positioned perpendicular to the axis of rotation of the celestial body and with an equator 106 that is similarly offset. In alternative embodiments, the IS coordinate system 100 may utilize other types of measurements to describe a position, such as by using two angles from a specified point, an angle of rotation and a distance from a specified point, or any other types of measurement or combinations of measurement.

As described previously, objects at a specified radial distance 112 may be described by two angles in some embodiments, the angle from the equator 114 and the angle from the reference meridian 116. The angles may be considered to be north/south or east/west of the reference circles, respectively, or may be any other type of measurement. The radial distance 112 may either be a range of distances or a single distance, as will be described in more detail subsequently. With the location of a user remaining at the center viewpoint 102, the orientation of the user to an object 110 may thus be defined by the radial distance 112, the angle from the equator 114, and the angle from the reference meridian 116.

Objects 110 may include any type of tangible or intangible item. Objects 110 may be fixed objects that remain stationary on a particular IS data shell 920 or mobile objects that may possibly move or change over time. Typical fixed objects would be political boundaries (e.g., borders), political locations (e.g., cities, towns, etc.), other locations (e.g., supply depot, airport, bus terminal), geographic items (e.g., mountain peak, shoreline, national park, forest), map-based lines (e.g., meridian lines, equators, angle demarcations, etc.), legends, historical locations of objects, target locations, commercial air-traffic routes, no-fly zones, ocean shipping lanes, railroad tracks, surface roads, subway tunnels, or any other fixed item. Mobile objects may be any type of item besides fixed objects, including but not limited to individuals or groups of individuals, vehicles (e.g., aircraft, delivery trucks, etc.), animals, items being tracked with a Global Positioning System receiver, money, satellites, inventory items, weather or atmospheric patterns (e.g., winds, global temperature patterns, etc.), oceanographic patterns, resources (e.g., oil deposits, diminishing forest resources), sociological/consumer or political patterns (e.g., voting trends, buying patterns, etc.), or any other item.

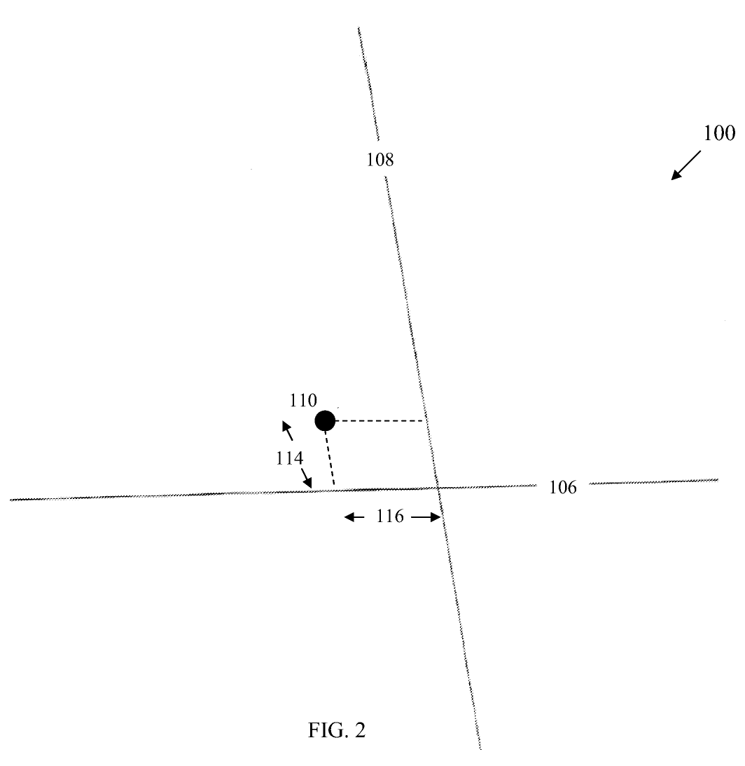

FIG. 2 depicts a cut-away, perspective view of the object 110 and IS coordinate system 100 of FIG. 1 from the internal point of view of the center viewpoint 102 according to some embodiments. Object 110 is positioned at an angle 114 from equator 106 and at an angle 116 from the reference meridian 108. When viewed from the position of the center viewpoint 102 (shown in FIG. 1), the object 110 may be viewed without geometric distortion. As any object 110 located anywhere within an IS formed based on a radial distance 112 will be viewed using the disclosed system from the same central viewpoint 102, any object at any angles 114, 116 may thus be viewed without geometric distortion.

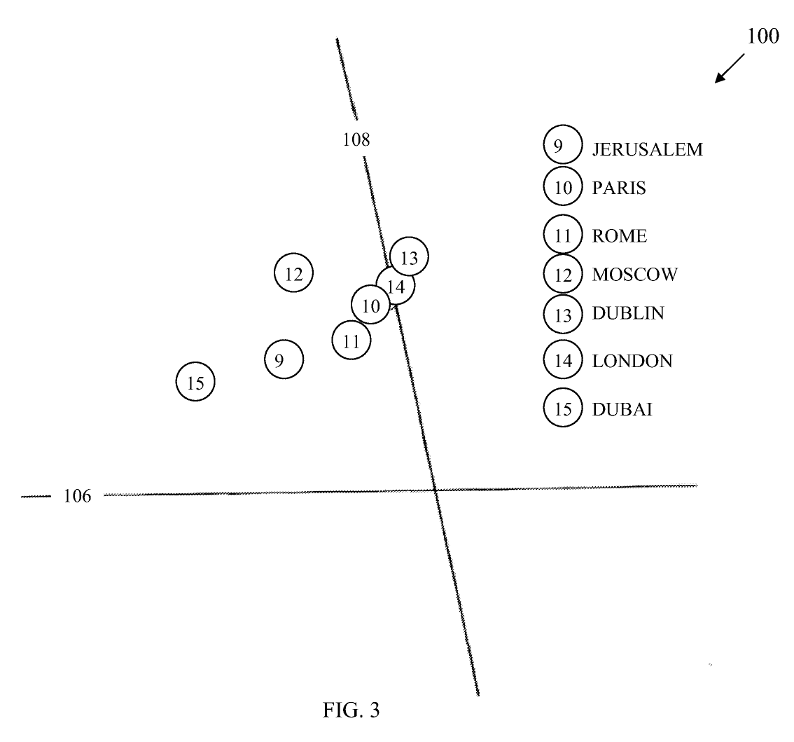

FIG. 3 depicts a cut-away, perspective view of the IS coordinate system 100 of FIG. 1 and various cities on the surface of the Earth from the internal point of view of the center viewpoint 102 according to some embodiments. The IS coordinate system 100 of FIG. 3 has the Prime Meridian as reference meridian 108 and a radial distance 112 that encompasses the surface of the Earth. The cities shown in FIG. 3 may be advantageously described by reference to the angles from the reference meridian 108 and equator 106, as described previously. The interior view of FIG. 3 is evidenced by Dublin, which is west of the Prime Meridian, being to the right of the reference meridian 108 in FIG. 3. When the cities of FIG. 3 are translated to an IS data shell, as will be described subsequently, the shortest distance between each will be depicted as a straight line drawn between them on the IS data shell. This may advantageously provide for an effective and efficient analysis of the relationship between objects 110 of an IS data shell and thus may provide for more intuitive analysis by individuals.

While embodiments of the IS data shell are depicted herein from the point of view of the center viewpoint 102 with east and west flipped in comparison to a traditional map, one of ordinary skill in the art will recognize that the presented objects 110 may also be flipped horizontally (i.e., about a vertical axis) to provide a view to users more consistent with how they would normally view maps (except without any horizons). In this alternative embodiment, California, for example, would be to the left of Colorado from the point of view of the center viewpoint instead of being to the right. A user may optionally transition back and forth between the two different views via user input command.

### Distortion Comparisons

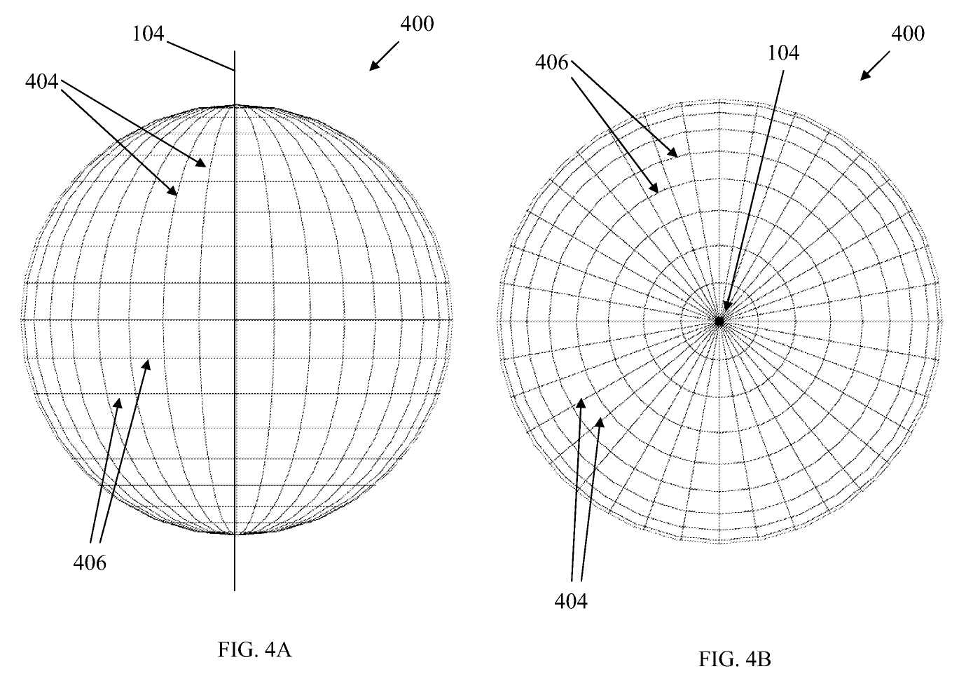

FIGS. 4A and 4B depict a side and top view from an external point of view, respectively, of latitude and longitude lines of a celestial body 400 that may represented by the IS coordinate system 100 according to some embodiments. The representation of celestial body 400 may include a plurality of longitude lines 404 and a plurality of latitude lines 406 at the surface of the celestial body 400. The representation may also include a central axis 104 on which the center viewpoint (not shown) may be located. The distortions to objects on the surface of the celestial body 400 using longitude lines 404 and the latitude lines 406 for mapping are seen in FIGS. 4A and 4B by the distortion of the four-sided shapes formed by intersecting longitude and latitude lines 404, 406. The distortion of surface objects is lowest at the point closest to an external viewer (seen in FIG. 4A as the intersection of the central, equatorial latitude line 406 and the central longitude line 404) and increases as one moves closer to the poles (i.e., intersection of central axis 104 with surface) and away from the closest point of the external viewer. The increasing distortion results in foreshortening of the four-sided shapes formed from the intersecting longitude and latitude lines 404, 406 until the very heavy distortion occurs near the poles and central axis 104.

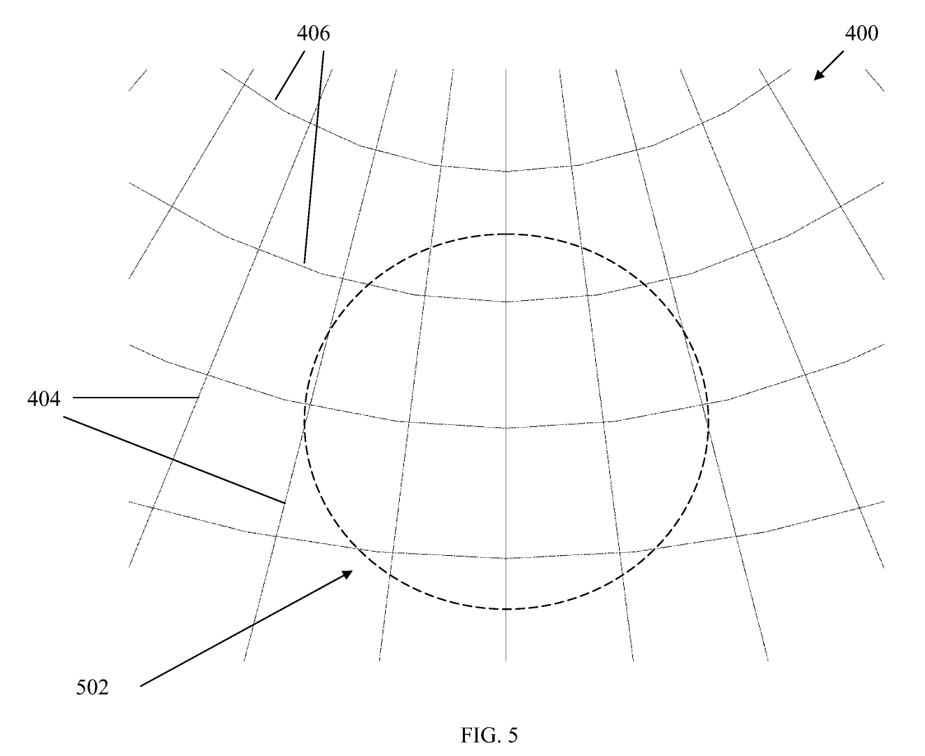

FIG. 5 depicts a partial upward looking view from the internal center viewpoint of latitude and longitude lines of the celestial body 400 of FIG. 4A and a typical focal view according to some embodiments. The internal view of FIG. 5 includes a sample focal view 502 (i.e., the intersection of the focal view and the IS data shell) of approximately 30 degrees. A map created from the area within the focal view 502 of FIG. 5 would be suitable for printing or display as a substantially non-distorted focal map. The portion of the view outside of the focal view 502 is a peripheral view portion and becomes increasingly distorted the further away from the focal area it becomes if printed in a map or other two-dimensional fashion. The peripheral portion of the view (and of course the focal view 502 portion) is not distorted when the content is viewed as an IS data shell as the view is from the fixed center viewpoint 102. The peripheral view portion of a view from a center viewpoint 102 may be any portion of the view outside the focal view 502 up to about a natural viewing limit of 180 degrees in width. The peripheral view is accurate and not distorted when viewed as part of an IS data shell, but this portion of the view will become more and more distorted as the field of view increases when viewed on a flat screen or a printed map.

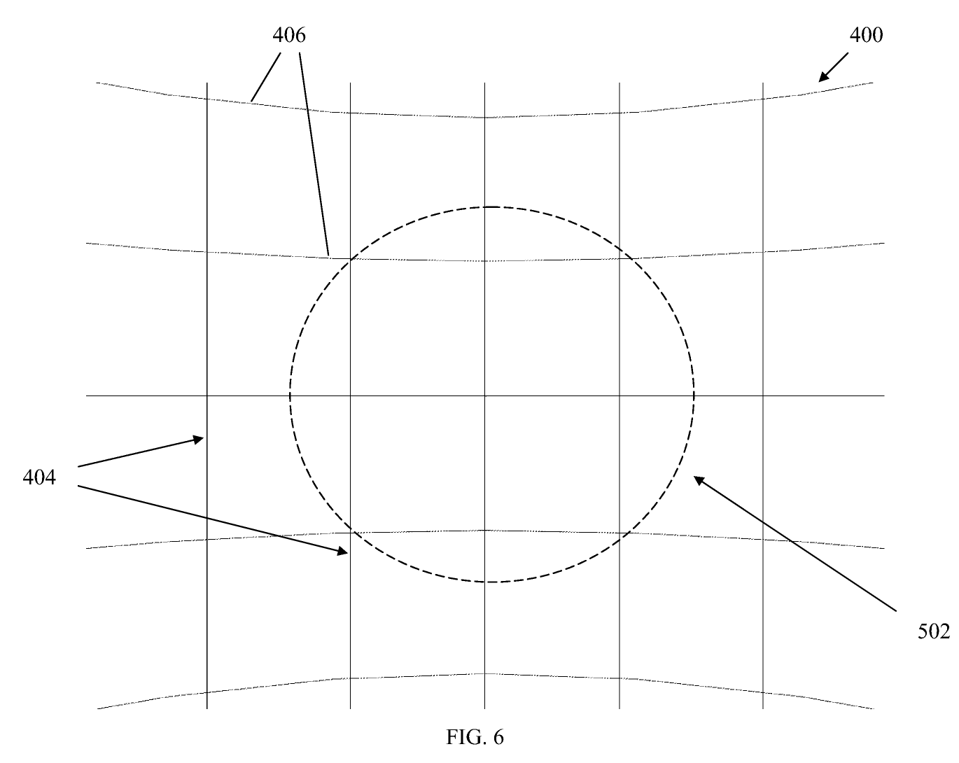

Longitude lines 404 and latitude lines 406 are depicted in FIG. 5 (and subsequently in FIG. 6) to illustrate relative distortions between systems based on IS data shells, focal maps (i.e., two-dimensional renderings of IS data shells), and conventional systems. In many embodiments of presented IS data shells, longitude lines 404 and latitude lines 406 will not be displayed as their presence may potentially confuse or mislead users as to relative positions of objects 110 or other viewing aspects.

FIG. 6 depicts a partial view from the internal center viewpoint of latitude and longitude lines of a celestial body 400 and a typical focal view 502 according to some embodiments. The view of FIG. 6 is from the point of view of the center viewpoint 102 (not shown) inside of the celestial body 400. As in the views of FIGS. 4A, 4B, and 5, the longitude lines 404 and latitude lines 406 form intersecting shapes that provide an indication of the distortion resulting in a two-dimensional focal map representing the three-dimensional celestial body 400. An internal view centered on the equatorial latitude line 404, as pictured, from the point of view of the center viewpoint 102 would result in very low distortion for objects near the equator and near the center of the viewing region. This lower-distortion area is represented by the approximately 30 degree focal view 502 of FIG. 6 (and FIG. 5) and thus any objects within these focal views 502 would have low distortion and be thus suitable for printing as a focal map. As described previously, the portion of the view outside the focal view 502 is the peripheral view portion and becomes increasingly distorted the further away from the focal view 502 if it becomes reduced to two-dimensions, such as on a map. This peripheral portion of the view is not distorted when it is viewed as part of an IS data shell and from the point of view of the fixed center point 102.

A sufficiently small focal view 502 does allow for acceptable levels of distortion even when printed on a map or otherwise viewing in two-dimensions. One of ordinary skill in the art will recognize that a level of distortion that is acceptable will vary based on application, as acceptable levels for one application may not be acceptable for others. An approximately thirty degree focal view 502 (or less) provides for relatively low levels of distortion for most applications, but it can be varied depending on accuracy needs.

As will be described in more detail subsequently, the system and methodologies of the disclosed embodiments provides for focal views 502 as well as peripheral views without any distortions when viewed as part of an IS data shell. If those views are reduced to two-dimensions by printing on a map or display on a traditional computer screen, distortions within the focal view 502 will likely remain acceptable and more significant distortions will likely only be visible in the peripheral portions. By representing objects from the internal point of view of a center viewpoint 102 instead of an external viewpoint as on an IS data shell equidistant from the fixed center viewpoint 102, objects near a specified user viewing direction (e.g., within the focal view 502) may be depicted in an IS data shell with no distortion and may be printed on a focal map with very little distortion.

FIGS. 5 and 6 both depict a view from the center viewpoint and thus provide an inside view. An IS data shell may appear similarly to FIGS. 5 and 6 (though likely without longitude lines 404 and latitude lines 406) and provide an enhanced view for users. An entire global view (along with any requested objects 110) may be presented without distortions and may provide for improved opportunities for analysis as global patterns and trends may be more easily recognized. Virtual reality goggles and physical IS data shells large enough to allow users to be physically inside them may therefore provide non-distorted views of both the focal view 502 region as well as peripheral view regions. The non-distorted spherical display may also allow the natural focus area to connect to peripheral focus areas so that pattern recognition may encompass the entire globe by the user intuitively moving their eyes from focal view 502 to focal view 502. In some embodiments, the focal view 502 may be enlarged by zooming in which narrows the view angle while providing more clarity to the area being analyzed. In some embodiments, a dashed circle or other indication may be provided within the user's views so that they may know the exact boundaries of the focal view 502, request to print the focal view 502 area, etc.

The IS data shell of the disclosed embodiments is flexible enough to encompass depiction of a wide variety of information in addition to the current position of objects 110. For example, the passage of time may be represented by a series of IS's taken at different times, by updating the position of objects 110 on the IS data shell based on positions changing over time, or other means. In other examples, multiple IS's may also be combined or superimposed so that two or more different sets of objects 110 may be compared so that the combination may be analyzed for patterns, issues, or information. In other examples, the representation of an object 110 on the IS data shell may be altered to provide additional information, such as by providing a flashing representation to indicate that the object 110 is about to leave the radial distance 112 or having the object 110 change color or emphasis to provide other information such as proximity to other objects, current status, etc. In yet another example, the tracking of the movement of objects 110 may be performed by overlaying multiple versions of the same IS at different times. One of ordinary skill in the art will recognize that many other alternatives, and combinations of alternatives, are possible and within the scope of the invention.

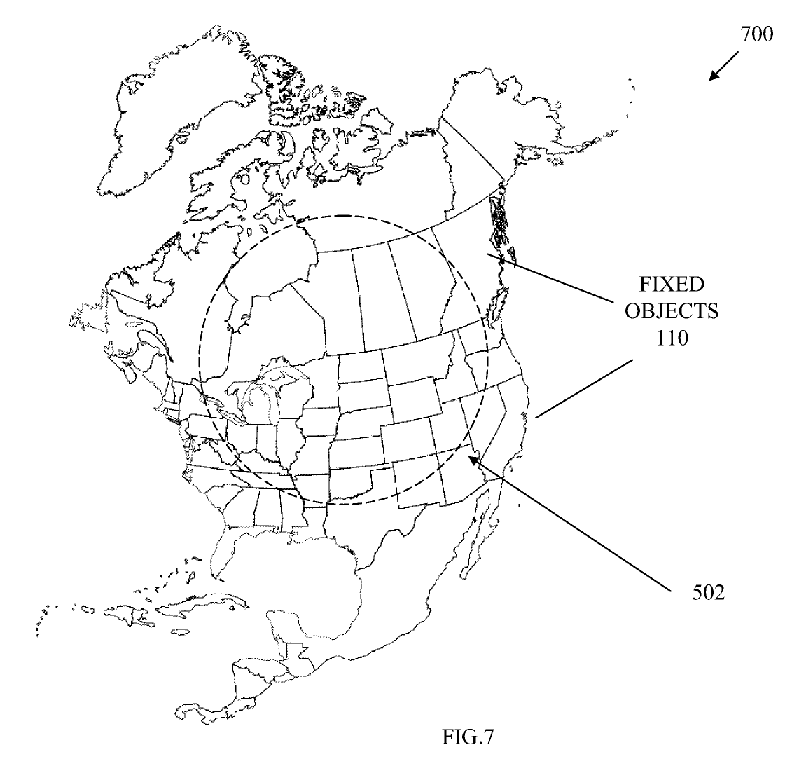

FIG. 7 depicts example fixed objects 110 viewed from the center viewpoint suitable for rendering on an IS data shell. The fixed objects 110 of FIG. 7 are political boundaries representing various political entities of North America. The fixed objects 110 of FIG. 7 are displayed from the point of view of a center viewpoint 102 of the Earth and thus are being viewed from “inside” the Earth. In some embodiments, political boundaries such as those depicted in FIG. 7 may be part of an IS that a user may select or deselect when viewing an IS data shell. Such IS's may be default or standard according to some embodiments as an initial starting IS. Other fixed or mobile objects 110 may be superimposed over these political boundary fixed objects 110 as part of an IS data shell according to various embodiments. A focal view 502 of approximately 30 degrees is also depicted on FIG. 7. As can be seen, most of the United States could be viewed in one 30 degrees focal view 502 with edge portions and neighboring regions being part of the peripheral view.

### Radial Distance

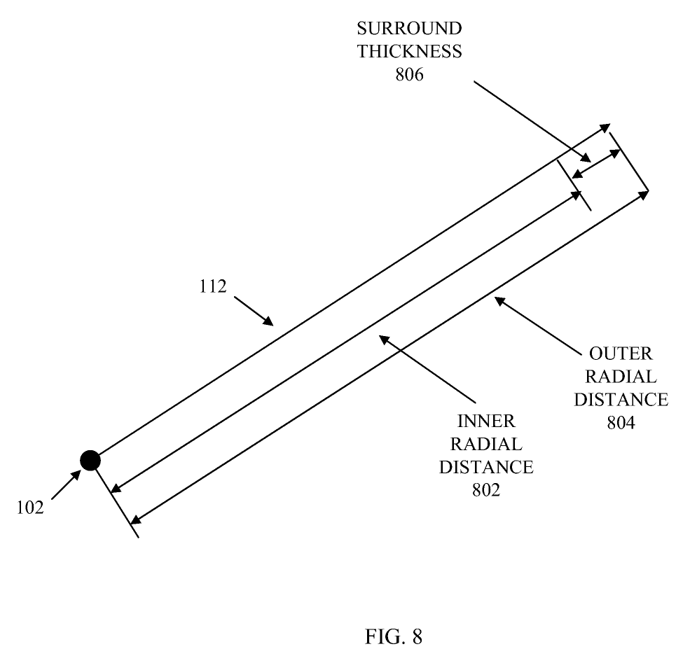

FIG. 8 depicts a center viewpoint 102 and a radial distance 112 according to some embodiments. In the depicted embodiment, the radial distance 112 includes a range of distances from the center viewpoint 102 and therefore encompasses any objects 110 that fall within the range of distances. The range of distances in the depicted embodiment extends from an inner radial distance 802 to an outer radial distance 804, with the distance between them being the surround thickness 806. According to an alternative embodiment, the radial distance 112 may be a single distance having a surround thickness 806 of zero. The range of distances extended as a spherical layer about the center viewpoint 102 may be considered an IS.

The surround thickness 806 may be chosen based on the desired objects 110 to present and may be adjusted as applicable to fit needs of a user or analyst. An oil drilling company may, for example, desire surround thicknesses 806 of one foot to precisely measure oil reserves while an air traffic controller may desire a surround thickness 806 of 40,000 feet to capture all commercial air traffic. The magnitude of the surround thickness 806, however, may impact the accuracy of the IS data shell. Relatively large surround thicknesses 806 may be used with minimal impact to accuracy. An IS based on a radial distance 112 extending from sea level to 40,000 feet (such as suitable for the commercial air traffic example) results in only a 0.2% difference in circumference between the inner radial distance 802 and the outer radial distance 804, a difference in accuracy that for most purposes will be irrelevant.

One of ordinary skill in the art will recognize that any range or distance for an IS (and thus radial distance 112) is possible. One type of IS may be based on atmospheric layers of the Earth, including IS's for all or part of the exosphere, ionosphere, troposphere, thermosphere, mesosphere, or stratosphere. Other types of IS's may include all or part of astronomical-based layers, including the magnetosphere. Yet other types of IS's would include all or part of the geologic layers such as the geosphere, inner core, outer core, mantle, lithosphere, asthensophere, oceanic crust, continental crust, Mohorovi\check{c}ić discontinuity, etc. Yet other types of IS may include very small or micro objects such as atoms, etc.

### Informational Surround Data Shells

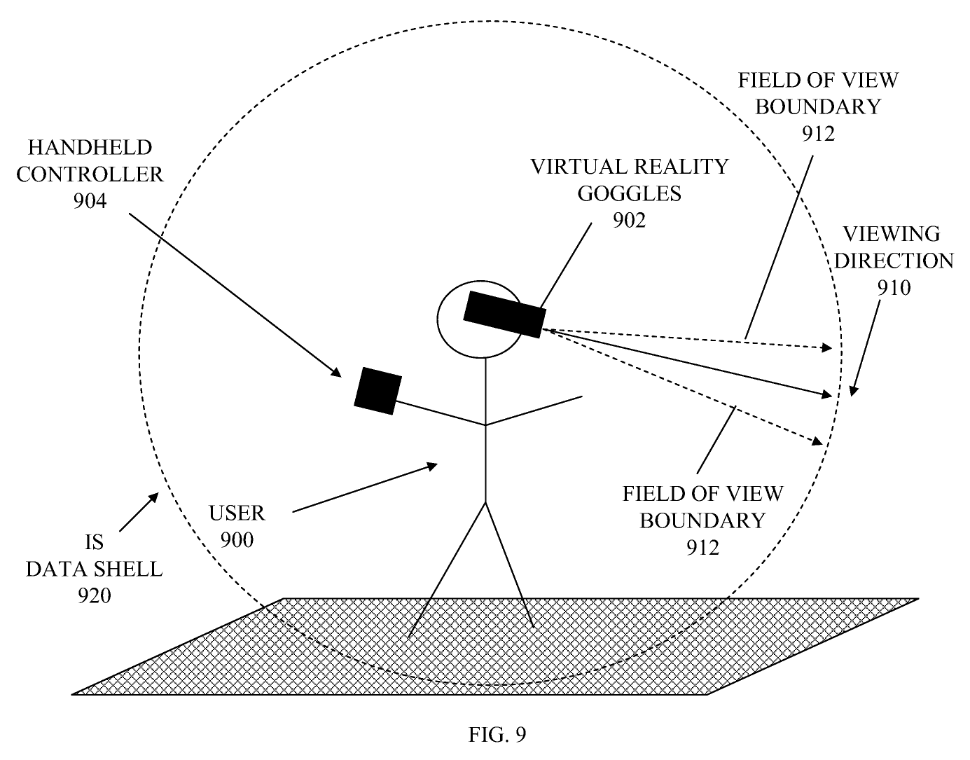

FIG. 9 depicts a schematic view of a user 900 using virtual reality goggles 902 to view an IS data shell 920 according to some embodiments. The user 900 of FIG. 9 may view the IS data shell 920 within a display (not shown) embedded in the virtual reality goggles 902. A display within virtual reality goggles 902 may provide a more immersive viewing experience than traditional displays. The virtual reality goggles 902 may also include an input device such as an orientation sensor or accelerometer to provide an indication of the direction the user is facing. The virtual reality goggles 902 may alternatively have other types of user input device, such as a voice input device or eye movement sensor, to detect a user's desired viewing direction or desired changes in viewing direction. In other embodiments, the user 900 may have a handheld controller 904 for providing input such as desired viewing direction 910, commands to zoom in or out, commands to add or remove types of objects, commands to change the field of view or radial distance 112, etc. While the embodiment of FIG. 9 is depicted with virtual reality goggles 902, one of ordinary skill in the art will recognize that any type of virtual reality device may be utilized, including but not limited to virtual reality helmets or other wearable devices.

The user's viewing direction 910 may be used to determine the IS data shell 920 or part thereof to display to the user 900 within the virtual reality goggles 902. The displayed portion of the IS data shell 920 may also have a field of view, depicted in FIG. 9 as the region between the two field of view boundaries 912. The user 900 may, in these embodiments, only view a partial IS data shell 920 at any one moment (i.e., the field of view corresponding with their desired viewing direction 910), but the display within the virtual reality goggles 904 may be quickly updated as the user 900 moves their head to a new viewing direction 910, thus providing a seamless viewing of any objects 110 within the entire IS data shell 920.

In some embodiments, the field of view may correspond to a focal view 502, but in many embodiments the field of view will be customizable by user 900. By receiving user input regarding desired viewing direction 910 (and optionally magnitude of the field of view) and using that to provide an updated display within the virtual reality goggles 902, a user 900 may use the virtual reality goggles 902 to efficiently navigate their view throughout an IS data shell 920. A user 900 may move their head and/or body, for example, to provide input of their desired viewing direction 910 and an updated display will be presented to them in the virtual reality goggles 902. In this embodiment, a user 900 may face upwards, downwards, and all around to see a full view of the entire celestial body 400 as if they were standing at a virtual center viewpoint 102. Such an ability may provide enhanced opportunities for analysis because of the perspective and lack of distortion as well as providing for potential entertainment opportunities. According to some embodiments, the virtual reality goggles 902 may be calibrated such that when level the equator is horizontal, when tipped up the north pole is seen, and when tipped down the south pole is seen. In these embodiments, objects to the east and west of a reference meridian may also be calibrated to be viewed as in the their virtual locations.

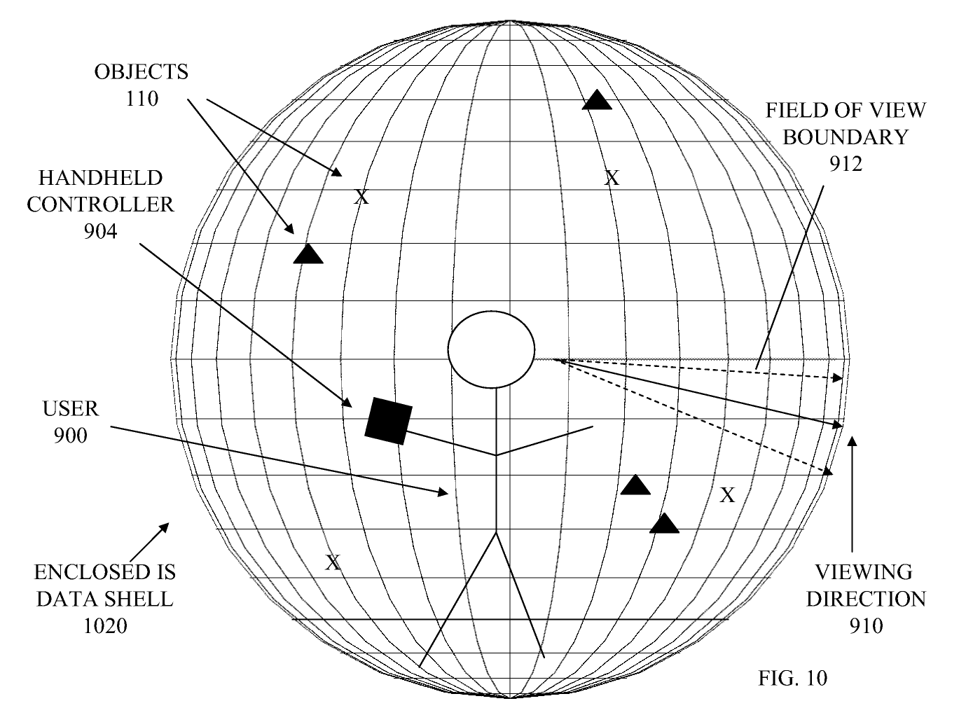

FIG. 10 depicts a partial cut-away side view of a user 900 using an enclosed IS data shell 1020 according to some embodiments. The user 900 of FIG. 10 may view the inner surface of the enclosed IS data shell 1020 (a physical enclosure) to view the generated IS data shell 920. In this embodiment, a user 900 may physically step inside the physical IS data shell 920 and be able to view presented data in any direction simply by turning their head. In this fashion, the user 900 may view objects 110 on a global scale without any distortions, providing the potential ability to detect patterns, trends, etc. that would otherwise not be evident. In some embodiments, multiple users 900 may also simultaneously be within the enclosed IS data shell 1020 so that they may view the same rendered objects and easily interact with each other. In this embodiment, the user 900 may view the entire (or substantially all of the entire) generated IS data shell 920 as all rendered objects 110 would be displayed simultaneously.

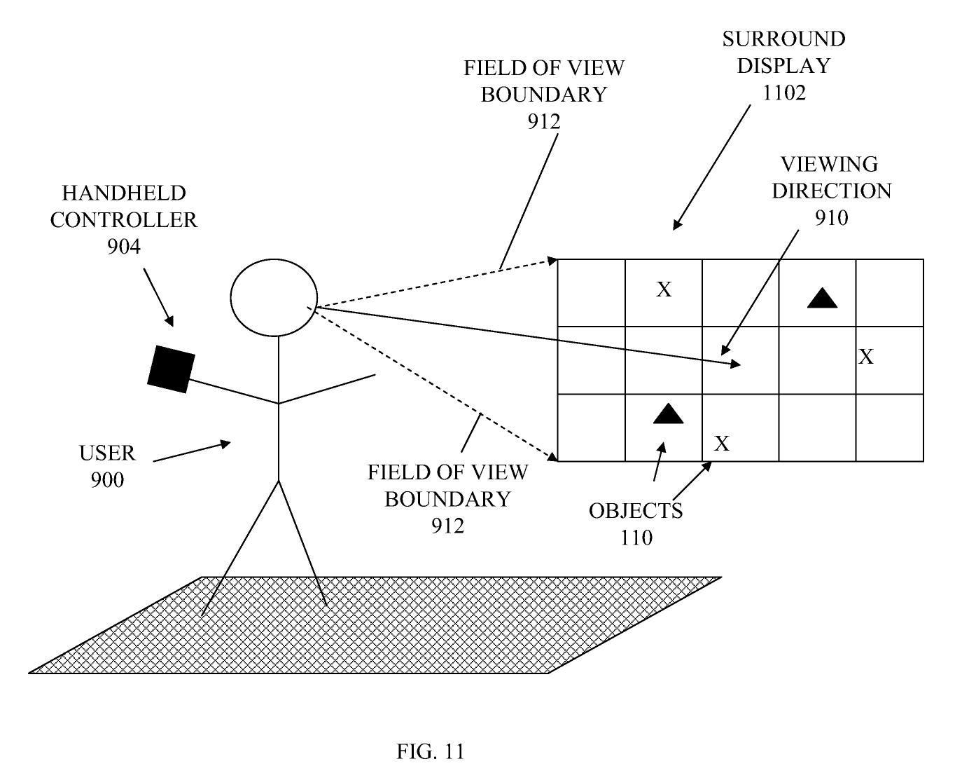

FIG. 11 depicts a schematic view of a user 900 using a surround display 1102 to view an IS data shell 920 according to some embodiments. In the depicted embodiment, the IS data shell 920 is a partial IS data shell 920 as it does not simultaneously present the entire sphere of a full IS data shell 920 as it is limited by the size of the surround display 1102. The user 900 may also have a handheld controller 904 or other user input device to provide information such as desired viewing direction 910, desired field of view, requests to modify the objects 110 displayed on the IS data shell 920, or other information. Any type of surround display 1102 may be used, including a computer screen, a television, a high definition television (HDTV), a curved concave display, a hemispherical display, or other type of display. The nature of the surround display 1102 may impact a user's desired field of view 912, such as if larger displays may result in larger acceptable fields of view for the user 900 while smaller ones limit acceptable fields of view.

### Informational Surround Systems and Methodologies

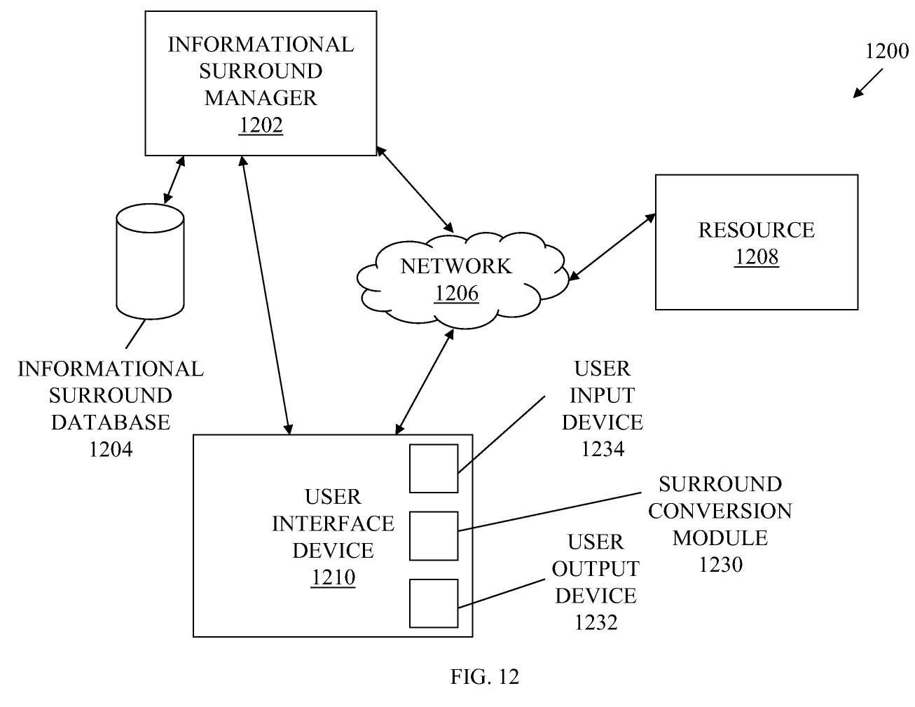

FIG. 12 depicts an IS system 1200 with an IS manager 1202, an associated IS database 1204, a network 1206, a resource 1208, and a user interface device 1210 according to some embodiments. The IS manager 1202 may be in communication with the IS database 1204, any resources 1208, and any user interface devices 1210 in any fashion, including directly, wirelessly, or via network 1206. As will be described in more detail subsequently, the IS system 1200 may facilitate creation and management of IS data shells 920, display or other presentation of IS data shells 920 to a user, and/or analysis and updating of created IS data shells 920.

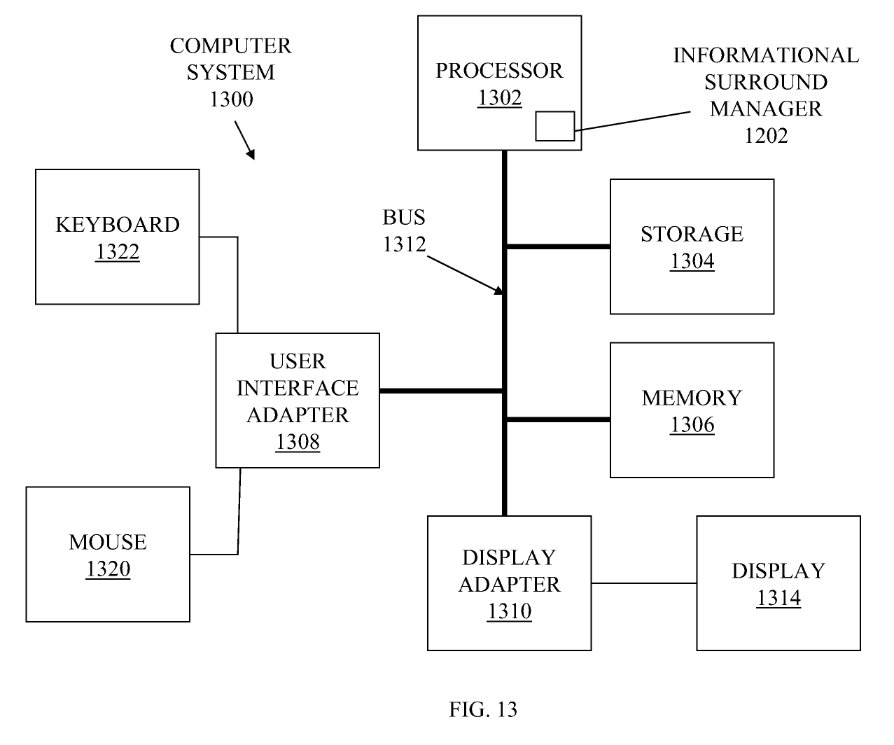

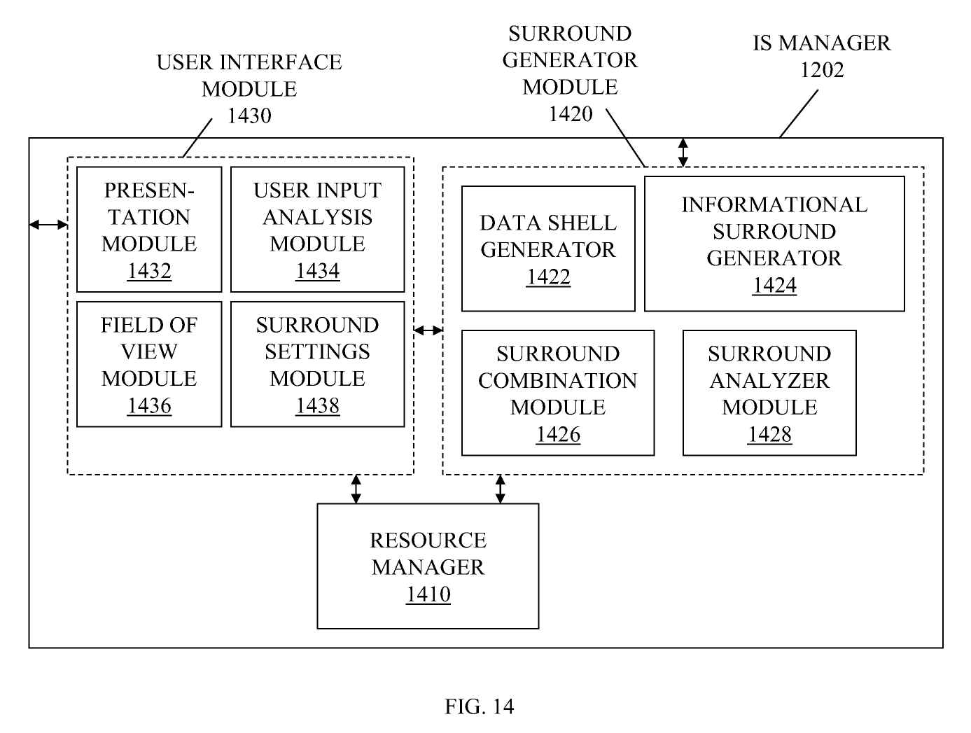

IS manager 1202 (which will be described in more detail in relation to FIG. 14) may be implemented on one or more servers or other computer systems (such as those described in relation to FIG. 13) according to some embodiments. In other embodiments, the IS manager 1202 may be implemented on a device having one or more processors, such as a set of virtual reality goggles 902. The IS database 1204 may provide storage for the IS manager 1202, including but not limited to user settings, generated IS data shells 920, position or other data for various objects 110, or any other information. The IS database 1204 may utilize any type or combination of storage devices, including volatile or non-volatile storage such as hard drives, storage area networks, memory, fixed or removable storage, or other storage devices.

Users 900 may utilize a user interface device 1210 according to the present embodiments to access the IS manager 1202 and thus request generated IS data shells 920 for presentation to a user. Communication between user interface devices 1210 and the IS manager 1202 may be via a network 1206, a wired link, a wireless link, or any other means. According to some embodiments, the user interface device 1210 may be a personal computer system or other computer system adapted to execute computer programs, such as a personal computer, workstation, server, notebook or laptop computer, desktop computer, personal digital assistant (PDA), mobile phone, wireless device, or set-top box, such as described in relation to FIG. 13. According to other embodiments, the user interface device 1210 may be dedicated IS hardware, virtual reality devices, an enclosed IS data shell 920, or any other device. In some embodiments, the IS manager 1202 and the user interface device 1210 may be part of the same physical device (e.g., virtual reality goggles 902 with both IS data shell 920 generation capability in addition to display capability) while in other embodiments they may be separate (e.g., an IS manager 1202 on a computer communicating with a remote user interface device 1210 via a network 1206, a server-based IS manager 1202 providing shared IS data shells 920 to multiple simultaneous users, etc.).

A user 900 of the user interface device 1210 may utilize any type of software to access the IS manager 1202, including dedicated software, a browser, or other software. Users 900 may include persons desiring to create or access IS data shells 920, analyze one or more generated shells, set up resource 1208 access, or any other function.

The user interface device 1210 may include a surround conversion module 1230, a user output device 1232, and a user input device 1234 to assist it in its task of presenting IS data shells 920 to users. The surround conversion module 1230 may convert an IS data shell 920 received from an IS manager 1202 into output commands (such as display commands). The user output device 1232 may receive the output commands and present the received IS data shell 920 to a user based on the output commands.

The user output device 1232 may be any type of device adapted to display an IS data shell 920, such as a computer screen, a television, a high definition television (HDTV), a curved concave display, a hemispherical display, a hologram display, an enclosed spherical display, a display within goggles (such as virtual reality goggles 902), a wearable display, or a virtual reality output device. The user output device 1232 may also optionally include other types of sensory output, such as devices to produce sound (for aural information) or smell (for olfactory information). The addition of other sensory information beyond visual data may, in some embodiments, provide for more sophisticated data for users 900. For example, the user output device 1232 may include directional sound based on a plurality of speakers that could provide directionally accurate indications of the occurrence of specified events (e.g., airplane taking off) so that a user 900 may quickly view the source of the sound.

The user input device 1234 may be any type of device adapted to receive input from a user, including a keyboard, a mouse, a trackball, a joystick, a voice input device, an orientation sensor within a virtual reality input device, an accelerometer-based sensor, an eye movement sensor, and a virtual reality input device.

Network 1206 may be any type of data communications channel or combination of channels, such as the Internet, an intranet, a LAN, a WAN, an Ethernet network, a wireless network, telephone network, a proprietary network, or a broadband cable network. In one example, the Internet may serve as network 1206 and the user interface devices 1210, the resources 1208, and the IS manager 1202 may communicate via the Internet using known protocols. Those skilled in the art will recognize, however, that the invention described herein may be implemented utilizing any type or combination of data communications channel(s) without departure from the scope and spirit of the invention.

Resources 1208 may include any sources of information associated with any objects 110. A resource 1208 may be implemented on a personal computer system or other computer system adapted to execute computer programs, such as a personal computer, workstation, server, notebook or laptop computer, desktop computer, personal digital assistant (PDA), mobile phone, wireless device, or set-top box, such as described in relation to FIG. 13. In some embodiments, the IS manager 1202 may require updated or current information about particular objects 110 that it is including in an IS. One or more resources 1208 may provide such information to the IS manager 1202, and a particular resource 1308 may provide information to a plurality of IS managers 1202. For example, a publicly-available resource 1208 may provide updated traffic information for the city of Chicago and any IS manager 1202 that desired to include current or historical traffic information for Chicago could request such data from that resource 1208. In another example, a resource 1208 may be a corporate internal database such as one that contains predicted coal deposits on company property. The types of resources 1208 that may be used is only limited by the type of information desired to create a particular IS data shell 920, and one of ordinary skill in the art will recognize that virtually any information source may be utilized as a resource 1208 according to the disclosed embodiments.

FIG. 13 depicts a block diagram of one embodiment of a computer system 1300 suitable for use as a component of the IS system 1300, such as a user interface device 1210 or a data processing system to execute the IS manager 1202. Other possibilities for the computer system 1300 are possible, including a computer having capabilities other than those ascribed herein and possibly beyond those capabilities, and they may, in other embodiments, be any combination of processing devices such as workstations, servers, mainframe computers, notebook or laptop computers, desktop computers, PDAs, mobile phones, wireless devices, set-top boxes, or the like. At least certain of the components of computer system 1300 may be mounted on a multi-layer planar or motherboard (which may itself be mounted on the chassis) to provide a means for electrically interconnecting the components of the computer system 1300.

In the depicted embodiment, the computer system 1300 includes a processor 1302, storage 1304, memory 1306, a user interface adapter 1308, and a display adapter 1310 connected to a bus 1312 or other interconnect. The bus 1312 facilitates communication between the processor 1302 and other components of the computer system 1300, as well as communication between components. Processor 1302 may include one or more system central processing units (CPUs) or processors to execute instructions, such as an IBM® PowerPC™ processor, an Intel Pentium® processor, an Advanced Micro Devices Inc. processor or any other suitable processor. The processor 1302 may utilize storage 1304, which may be non-volatile storage such as one or more hard drives, tape drives, diskette drives, CD-ROM drive, DVD-ROM drive, or the like. The processor 1302 may also be connected to memory 1306 via bus 1312, such as via a memory controller hub (MCH). System memory 1306 may include volatile memory such as random access memory (RAM) or double data rate (DDR) synchronous dynamic random access memory (SDRAM). In the disclosed systems, for example, a processor 1302 may execute instructions to perform functions of the IS manager 1202, such as by generating an IS data shell 920, and may temporarily or permanently store information during its calculations or results after calculations in storage 1304 or memory 1306. All or part of the IS manager 1302, for example, may be stored in memory 1306 during execution of its routines.

The user interface adapter 1308 may connect the processor 1302 with user interface devices such as a mouse 1320 or keyboard 1322. The user interface adapter 1308 may also connect with other types of user input devices, such as touch pads, touch sensitive screens, electronic pens, joysticks, eye movement sensors, microphones, etc. A user of a user interface device 1310 attempting to request access to a stored IS data shell 920, for example, may utilize the keyboard 1322 and mouse 1320 to interact with their computer system. The bus 1312 may also connect the processor 1302 to a display 1313, such as an LCD display or CRT monitor, via the display adapter 1310. A generated IS data shell 920 may be presented to a user or analyst via display 1314 according to some embodiments, for example, so that they can visually seek out patterns or other information. According to some alternative embodiments, an immersive virtual reality system may be used for display 1314 to more efficiently display information to a user.

FIG. 14 depicts a conceptual illustration of software components of an IS manager 1202 according to some embodiments. The IS manager 1202 may be implemented on a computer system 1300 such as described in relation to FIG. 13, including on one or more servers, or may be implemented on other hardware such as a dedicated IS machine or virtual reality goggles 902 or any other device. The IS manager 1202 may manage various aspects of IS data shells 920, such as by facilitating creation of IS data shells 920, providing for transmission of a generated IS data shell 920 to an user interface device 1210 for presentation, or facilitating various forms of analysis of the IS data shells 920. The IS manager 1202 may include components to assist it with its functions, including a resource manager 1410, a surround generator 1420, and a user interface module 1430. One of ordinary skill in the art will recognize that the functionality of each component and sub-component of the IS manager 1202 may be combined or divided in any fashion and the description herein is merely intended to be illustrative of some embodiments.

The resource manager 1410 may interact with various resources 1208 each having information about one or more objects 110 to acquire information used to add objects 110 to an IS data shell 920. The resource manager 1410 may thus acquire information about objects 110, process or analyze it as necessary, and provide such information to the surround generator module 1420.

The surround generator module 1420 may generate an IS data shell 920 from a point of view of a single fixed center viewpoint 102 of a three-dimensional celestial body 400 such as the Earth. The surround generator module 1420 may include its own components, such as a data shell generator module 1422, an IS generator 1424, a surround combination module 1426, and a surround analyzer module 1428, to assist it in performance of its tasks.

The data shell generator module 1422 may generate a data shell from the point of view of the center viewpoint 102 based on a determined radial distance 112 from the center viewpoint 102. The IS generator 1424 may generate objects 110 associated with a requested IS, each at the determined radial distance 110 from the center viewpoint 102, for rendering in the generated data shell based on the position of each object 110 relative to the celestial body 400. The surround combination module 1426 may generate an IS data shell 920 by rendering generated objects, each associated with a requested IS, within the generated data shell based on their position relative to the celestial body 400. The data shell may thus serve as a “blank canvas” upon which one or more IS's, and their component objects 110, are rendered to form the complete IS data shell 920. Users 900 may select which IS's, and thus which objects 110, are included. Users 900 may also, in some embodiments, vary the IS's they are viewing by requesting the additional or removal of particular IS's from the IS data shell 920.

The surround analyzer module 1428, which is described in more detail subsequently, may receive requests to analyze two or more objects 110 on an IS data shell 920, may analyze the objects 110 to determine relationships between them, and to generate analysis results. The surround analyzer module 1428 may also receives requests to change objects 110 to be analyzed and update the analysis results appropriately. Automated analysis such as that performed by the surround analyzer module 1428, may be particularly suitable for computationally-intensive analysis such as optimizing vehicles routes, determining optimal resource extraction plans, or other types of analysis. In some embodiments, automated analysis may be used in conjunction with human-based analysis to supplement and leverage the results of each.

The user interface module 1430 may facilitate communication to and from users utilizing user interface devices 1210, including receiving requests to generate IS data shells 920 and transmitting generated IS data shells 920 to requesting users 900. The user interface module 1430 may include sub-components to assist it in performing its tasks, including a presentation module 1432, a user input analysis module 1434, a field of view module 1436, and a surround settings module 1438. The presentation module 1432 may transmit to a user interface device 1210 a generated IS data shell 920 (optionally based on a user's current desired viewing direction) for presentation of the generated IS data shell 920 to the user 900.

The user input analysis module 1434 may receive requests from users to view an IS data shell 920 and to receive from a user 900 via a user input device, for example, an indication of a current desired viewing direction for viewing the IS data shell 920. The optional field of view module 1436 may determine a field of view for the user when viewing the IS data shell 920, such as based on defaults, the nature of the particular IS data shell 920, or user preference. The surround settings module 1438 may also receive and process other types of user input in conjunction with the user input analysis module 1434, including requests to change field of view, change the number or type of objects displayed, change the zoom level, or other information.

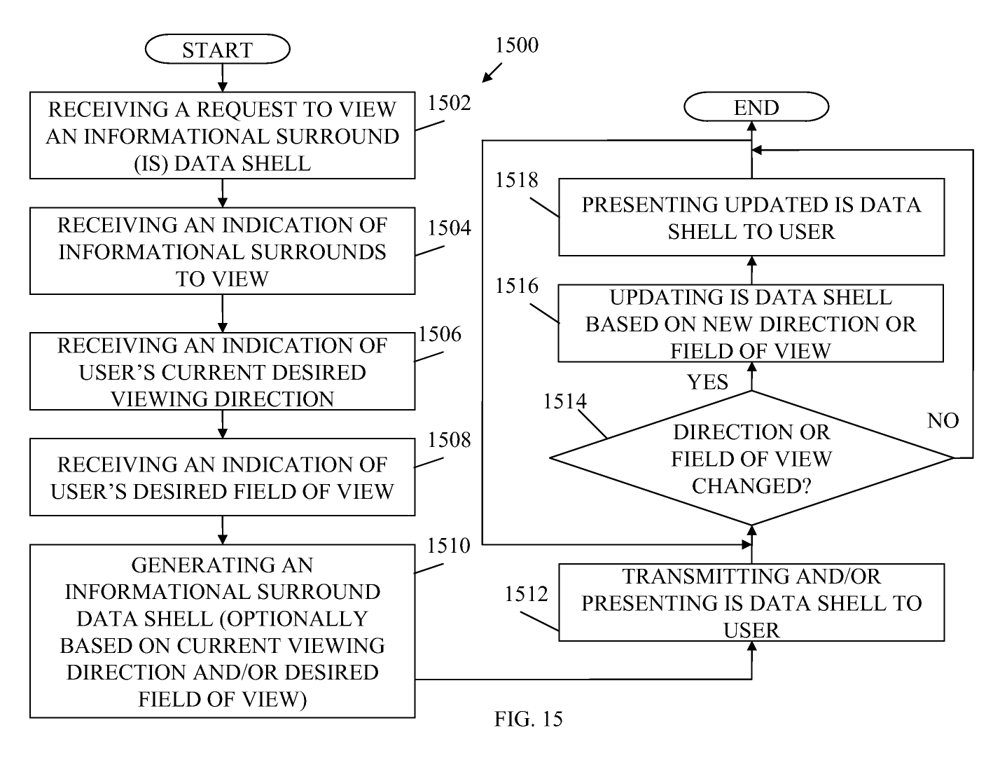

FIG. 15 depicts an example of a flow chart 1500 for presenting a generated IS data shell 920 to a user 900 according to some embodiments. The method of flow chart 1500 may be performed, in one embodiment, by the user interface module 1430 of the IS manager 1202 in conjunction with components of a user interface device 1210. Flow chart 1500 begins with element 1502, receiving a request to view an IS data shell 920. As described previously, the IS data shell 920 may depict a position for one or more objects (each part of an IS) relative to a three-dimensional celestial body 400 from a point of view at a single center viewpoint 102 inside of the celestial body 400. At optional element 1504, flow chart 1500 may also receive an indication of which IS's (and thus which objects 110) to view. For example, a user may request to be presented with positions for one or more IS's (e.g., surrounds with winds and aircraft in flight), and such requested objects may be in addition to a default set of IS's (e.g., political boundaries). At optional element 1506, flow chart 1500 may receive an indication of the user's current desired viewing direction for viewing the IS data shell. At optional element 1508, flow chart 1500 may also receive an indication of the user's desired field of view. According to some embodiments, the request received at element 1502 may include one or more of requested IS's to view, desired viewing direction, and/or field of view.

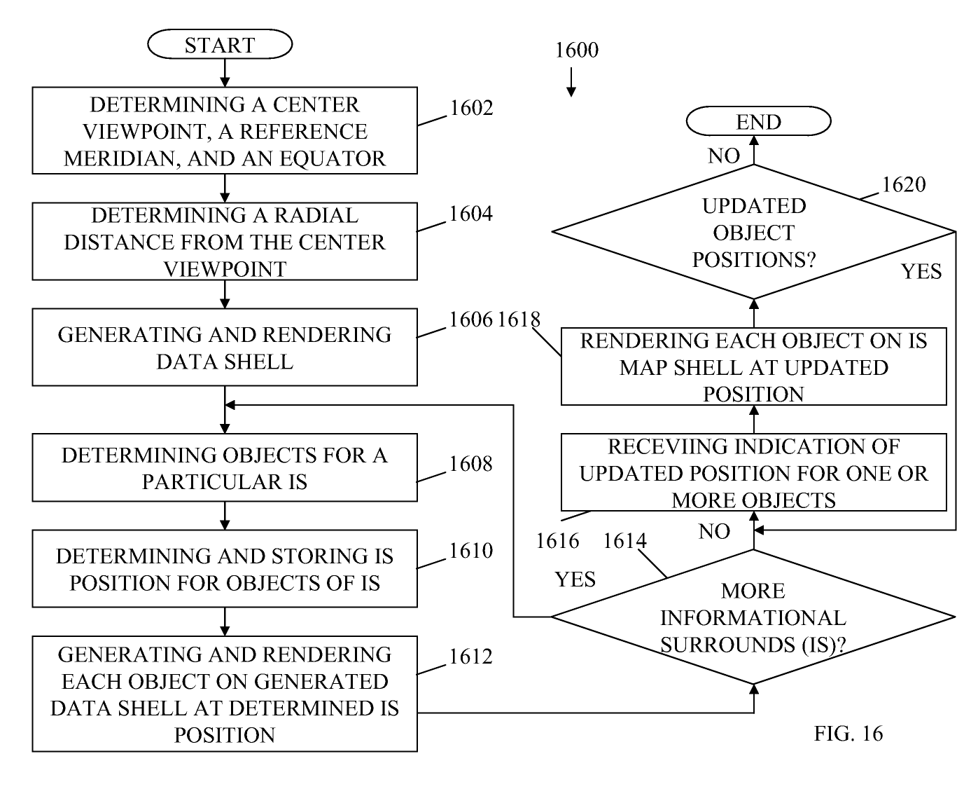

After receiving information from the user 900, flow chart 1500 may continue to element 1510, generating the IS data shell 920 from a point of view of the single center viewpoint 102. The generation of the IS data shell 920, described in more detail in relation to FIG. 16, may be optionally based on the desired viewing direction and/or desired field of view. At element 1512, flow chart 1500 may transmit to a user output device (such as a user interface device 1210) the generated IS data shell 920 for presentation to the user 900 or, in the event that both functions are contained in the same device, presenting the IS data shell 920 to the user 900.

At decision block 1514, flow chart 1500 may determine if a user's desired viewing direction or field of view has changed (in the event that a fully spherical display is not being used), such as based on received changes to the user's desired viewing direction input via a user input device 1234. If there has been a change, flow chart 1500 continues to element 1516, generating an updated IS data shell 920 based on the new viewing direction and/or field of view, and then transmitting the updated IS data shell 920 to the user output device 1232 at element 1518, after which the method either terminates or returns to decision block 1514 to await further input from a user 900. In this fashion, the display of an IS data shell 920 to a user 900 may be continuously updated as the user changes their desired viewing direction or other variables. Any changes to the underlying information (such as positions of objects 110) may also be accommodated in updated IS data shells 920, providing a continuously updated display.

FIG. 16 depicts an example of a flow chart 1600 for generating an IS data shell 920 depicting one or more objects 110 according to some embodiments. Flow chart 1600 provides an example methodology for implementing element 1510 of FIG. 15. The method of flow chart 1800 may be performed, in one embodiment, by components of the IS manager 1202 such as the IS generator module 1424. Flow chart 1600 begins with element 1602, determining a center viewpoint 102, a reference meridian 108, and an equator 106 for the IS data shell 920. The method may also at element 1604 determine a radial distance 112 from the center viewpoint 102 for the IS data shell 920. The determination of elements 1602 and 1604 may, in some embodiments, be determined based on information received in the request received at element 1502 of FIG. 15 (such as if the radial distance 112, etc. were contained within the request). In other embodiments, default or other pre-set values may be utilized for one or more of the variables, such as by using a standard center viewpoint 102, equator 106, and the Prime Meridian for the reference meridian 108 absent instructions to the contrary.

Elements 1608 through 1614 may be performed for each IS that will be included with the generated IS data shell. The method first continues to element 1606, generating a data shell from a point of view of the center viewpoint 102 for the IS data shell. Method 1600 may then continue to element 1608, determining which objects 110 should be rendered for a particular selected IS. Method 1600 may then at element 1610 determine and store the IS position for the objects 110, such as by requesting an IS position from a position converter module 1522 (as described in relation to FIG. 15). The method may then at element 1612 render each object 110 of the IS within the generated data shell at its determined IS position relative to the celestial body 400. At decision block 1614, the method determines whether other IS's are still remaining and if so, execution returns to element 1608 for rendering processing another IS.

Once an IS data shell has been generated, the method may optionally at element 1616 receive an indication of updated positions or other information for one more objects 110 and may at element 1618 render each updated objects on the data shell at its updated position. At decision block 1620, the method may determine whether object positions will continue to be updated and if so, returns to element 1616 for continued processing and, if not, the method terminates.

The methodology of the disclosed embodiments may provide for enhanced analysis of any form of data that can be presented on an IS data shell. By overlaying multiple IS's, a user 900 may analyze the presented objects 110 to attempt to recognize patterns, relationships, or other aspects that may not otherwise be evident when using traditional methodologies. By removing variables to consider (i.e., using a set radial distance 112) and presenting objects and their relationships without distortion, a user may experience a paradigmatic shift brought about by leaving the existing intellectual cumbersomeness of navigating distorted mapping systems and entering into the more accurate systems of the disclosed embodiments. Smooth transitions from focal areas to peripheral areas also help to improve the ability to analyze information as a user 900 may quickly and efficiently change their view to look at other pieces of data. A few non-limiting examples may prove to be helpful in understanding the disclosed embodiments and their application.

In one example, an airborne shipper may desire to have an IS data shell 920 for their logistical operations. The radial distance 112 may be a range of 3950-3958 miles from the center viewpoint 102 at the Earth's center, a range corresponding with typical commercial airspace. The shipper of this example may request that IS's be included representing political boundaries, winds, hub locations, airport locations, current locations of their aircraft, and current locations of items in transit. An analyst may view the resulting IS data shell and determine, for example, that two hubs are too close and that one can safely be shut down. The same analyst may also determine that a particular hub is a bottleneck and that a second hub may result in improved efficiencies. An analyst may also notice that a route that is often delayed also has a shifted wind pattern with more headwinds and thus diagnose a problem in scheduling. An automated analyzer, in another example, may determine that a particular cargo aircraft should divert from its current hub destination to a new destination hub because of anticipated fuel consumption, weather patterns, or other factors.

In another example, a resource management company may generate an IS data shell for management of an underground resource such as coal, oil, or groundwater. The radial distance 112 for this may be a range of sea level to 200 feet below sea level. In this example, the company may desire IS's representing geologic features, drilling rig locations, known resource deposits, and type of rock. Analysts may, therefore, quickly and efficiently compare drilling rig placement with the contours of the underground resource to determine if drilling rig placement may be improved. Resource modeling may be particularly suited for superimposing IS's representing sub-distances of the full radial distance 112 each representing a small ‘slice’ of radial distance 112 (e.g., 150-155 feet, 155-160 feet, etc.) so that resources may be more effectively presented.

A number of non-limiting examples of analysis that may be performed on objects 110 and IS data shells 920 are disclosed herein, and one of ordinary skill in the art will recognize that any type of combination of analysis may be performed with the system and methodology of the disclosed embodiments. Another example would be an IS data shell 920 presenting hurricanes with drought areas (i.e., a hurricane IS and a rainfall IS) to attempt to determine correlations between them. Yet another example would be presenting public opinion (as acquired via polling) over a geographic area to determine the efficacy of political or product ads. Another example would be to track the movements of a number of important people over a period of time to attempt to detect patterns or relationships between them, as might be useful in tracking suspects in a criminal investigation or tracking the influence of popular culture among influential people. Another example would be for use as tracking the location of a large and varied fleet of vehicles (e.g., boats, aircraft, ground vehicles, etc.) and associated logistics. Many other examples are possible and are enabled by the disclosed system and methodology.

The disclosed system and methodology may advantageously provide for IS data shells 920 that are substantially free of distortion and, because of the fixed radial distance 112, only two variables are needed to describe the position of an object 110 or the distance between two objects 110. As distortion can be considered a variable the human mind must consider when analyzing a visual display of information, the disclosed system may further reduce the number of variables a person must consider when analyzing information, resulting in increased efficiency and an improved possibility of detecting patterns or other additional aspects of information. Users may quickly and efficiently view a portion of an IS data shell 920 based on the desired viewing direction and may also effectively change their desired viewing direction and thus their view. Particularly when combined with sophisticated displays, the methodologies of the disclosed embodiments provide a flexible and efficient way of generating and displaying information that is a radial distance 112 from a center viewpoint 102.

In general, the routines executed to implement the various disclosed embodiments may be part of a specific application, component, program, module, object, or sequence of instructions. The computer program of the disclosed embodiments typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

While specific embodiments are described herein with reference to particular configurations of hardware and/or software, those of skill in the art will realize that embodiments of the present invention may advantageously be implemented with other substantially equivalent hardware, software systems, manual operations, or any combination of any or all of these. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Moreover, embodiments of the invention may also be implemented via parallel processing using a parallel computing architecture, such as one using multiple discrete systems (e.g., plurality of computers, etc.) or an internal multiprocessing architecture (e.g., a single system with parallel processing capabilities).

Aspects of embodiments of the invention described herein may be stored or distributed on computer-readable medium as well as distributed electronically over the Internet or over other networks, including wireless networks. Data structures and transmission of data (including wireless transmission) particular to aspects of the invention are also encompassed within the scope of the invention. Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Each software program described herein may be operated on any type of data processing system, such as a personal computer, server, etc. A data processing system suitable for storing and/or executing program code may include at least one processor coupled directly or indirectly to memory elements through a system bus. The memory elements may include local memory employed during execution of the program code, bulk storage, and cache memories which provide temporary storage of at least some program code in order to reduce the number of times code must be retrieved from bulk storage during execution. Input/output (I/O) devices (including but not limited to keyboards, displays, pointing devices, etc.) may be coupled to the system either directly or through intervening I/O controllers. Network adapters may also be coupled to the system to enable the data processing system to become coupled to other data processing systems or remote printers or storage devices though intervening private or public networks, including wireless networks. Modems, cable modems and Ethernet cards are just a few of the currently available types of network adapters.

It will be apparent to those skilled in the art having the benefit of this disclosure that the present invention contemplates methods, systems, and media for presenting data based on a fixed center viewpoint. It is understood that the form of the invention shown and described in the detailed description and the drawings are to be taken merely as examples. It is intended that the following claims be interpreted broadly to embrace all the variations of the example embodiments disclosed.

What is claimed is:

1. A computer-implemented method for facilitating presentation of data based on a fixed center viewpoint, the method comprising:
receiving a request for an informational surround data shell to be presented to a user from a point of view at a single fixed center viewpoint inside of a celestial body, the requested informational surround data shell comprising one or more informational surrounds, each of the one or more informational surrounds comprising one or more objects to be presented to the user within the informational surround data shell;
determining a radial distance from the center viewpoint of the celestial body for the informational surround data shell;
generating a data shell from a point of view of the center viewpoint based on the determined radial distance;
for each of the one or more requested informational surrounds, generating one or more associated objects, each at the radial distance from the center viewpoint, for rendering in the generated data shell based on the position of each object relative to the celestial body;
generating the informational surround data shell from the point of view of the center viewpoint by rendering each of the one or more generated objects within the generated data shell based on their position relative to the celestial body, the informational surround data shell comprising both the generated data shell and the one or more generated objects rendered within the generated data shell based on their position relative to the celestial body; and
transmitting the generated informational surround data shell for presentation to the user.

2. The method of claim 1, wherein transmitting the generated informational surround data shell comprises transmitting the generated informational surround data shell to a user output device for presentation to the user.

3. The method of claim 1, further comprising presenting the generated informational surround data shell to the user.

4. The method of claim 1, further comprising:
receiving an indication of a new position for at least one object; and
rendering the at least one object within the generated data shell based on its new position.

5. The method of claim 1, wherein the generated informational surround data shell is substantially spherical and centered about the center viewpoint.

6. The method of claim 1, wherein the generated informational surround data shell is a partial informational surround data shell of less than a complete sphere and centered about the center viewpoint.

7. The method of claim 1, further comprising receiving, from a user via a user input device, an indication of a desired viewing direction for viewing the informational surround data shell.

8. The method of claim 7, wherein generating the informational surround data shell comprises generating the informational surround data shell based on the user's desired viewing direction.

9. The method of claim 1, further comprising receiving, from the user via a user input device, an indication of a desired field of view for viewing the informational surround data shell.

10. The method of claim 9, wherein generating the informational surround data shell comprises generating the informational surround data shell based on the user's desired field of view.

11. The method of claim 1, further comprising receiving, from the user via a user input device, an indication of which informational surrounds to include in generating informational surround data shells.

12. The method of claim 1, wherein the celestial body is the Earth.

13. The method of claim 1, wherein the position relative to the celestial body of each of the one or more objects rendered on the informational surround data shell comprises an angle from a reference meridian of the celestial body and an angle from an equator of the celestial body.

14. The method of claim 1, wherein the request to view an informational surround data shell comprises a desired radial distance from the center viewpoint, and wherein further determining the radial distance comprises setting the radial distance equal to the desired radial distance.

15. The method of claim 1, wherein the radial distance is a single distance from the center viewpoint of the celestial body.

16. The method of claim 1, wherein the radial distance is a range of distances from the center viewpoint of the celestial body extending from an inner radial distance to an outer radial distance.

17. The method of claim 1, wherein generating the one or more associated objects based on the position of each object relative to the celestial body comprises generating the one or more objects based on the position of each object at a particular time.

18. A computer program product comprising a computer-useable medium having a computer readable program, wherein the computer readable program when executed on a computer causes the computer to perform a series of operations for:
receiving a request for an informational surround data shell to be presented to a user from a point of view at a single fixed center viewpoint inside of a celestial body, the requested informational surround data shell comprising one or more informational surrounds, each of the one or more informational surrounds comprising one or more objects to be presented to the user within the informational surround data shell;
determining a radial distance from the center viewpoint of the celestial body for the informational surround data shell;
generating a data shell from a point of view of the center viewpoint based on the determined radial distance;
for each of the one or more requested informational surrounds, generating one or more associated objects, each at the radial distance from the center viewpoint, for rendering in the generated data shell based on the position of each object relative to the celestial body;
generating the informational surround data shell from the point of view of the center viewpoint by rendering each of the one or more generated objects within the generated data shell based on their position relative to the celestial body, the informational surround data shell comprising both the generated data shell and the one or more generated objects rendered within the generated data shell based on their position relative to the celestial body; and
transmitting the generated informational surround data shell for presentation to the user.

19. A data processing system having a machine-accessible medium storing a plurality of program modules, the system comprising:
a surround generator module to generate an informational surround data shell from a point of view of a single fixed center viewpoint of a celestial body, the surround generator module comprising:
a data shell generator to generate a data shell from the point of view of the center viewpoint based on a determined radial distance from the center viewpoint;
an informational surround generator to generate objects associated with a requested informational surround, each at the determined radial distance from the center viewpoint, for rendering in the generated data shell based on the position of each object relative to the celestial body; and
a surround combination module to generate an informational surround data shell by rendering generated objects, each associated with a requested informational surround, within the generated data shell based on their position relative to the celestial body; and
a user interface module, in communication with the surround generator module, to receive input from users and to provide output to users, the user interface module comprising:
a user input analysis module to receive requests to view an informational surround data shell and to receive inputs from a user input device; and
a presentation module to transmit to a user output device the generated informational surround data shell for presentation of the generated informational surround data shell to a user.

20. The system of claim 19, wherein the generated informational surround data shell is substantially spherical and centered about the center viewpoint.

21. The system of claim 19, wherein the generated informational surround data shell is a partial informational surround data shell of less than a complete sphere and centered about the center viewpoint.

22. The system of claim 19, wherein the user input analysis module receives an indication of a user's current desired viewing direction for viewing the informational surround data shell, and wherein further the surround generator module generates the informational surround data shell based on the user's current desired viewing direction.

23. The system of claim 19, wherein the user input analysis module receives an indication of a user's current desired field of view for viewing the informational surround data shell, and wherein further the surround generator module generates the informational surround data shell based on the user's current desired field of view.

24. The system of claim 19, wherein the user interface module further comprises a field of view module to determine a field of view for the user when viewing the informational surround data shell.

25. The system of claim 19, wherein the user interface module further comprises a surround settings module to determine a radial distance from the single center viewpoint of the celestial body for the informational surround data shell.

26. The system of claim 19, wherein the radial distance is a single distance from the center viewpoint of the celestial body.

27. The system of claim 19, wherein the radial distance is a range of distances from the center viewpoint of the celestial body extending from an inner radial distance to an outer radial distance.

28. The system of claim 19, wherein the celestial body is Earth.

29. The system of claim 19, wherein the user input device is one or more of a keyboard, a mouse, a trackball, a joystick, a voice input device, an orientation sensor within a virtual reality input device, an accelerometer, an eye movement sensor, and a virtual reality input device.

30. The system of claim 19, wherein the user output device is one or more of a computer screen, a television, a high definition television (HDTV), a curved concave display, a hemispherical display, a spherical display, a hologram display, a display within goggles, a wearable display, and a virtual reality output device.

31. A system for presenting data to a user, the system comprising:
a data processing system having a machine-accessible medium storing a plurality of program modules, comprising:
a surround generator module to generate an informational surround data shell from a point of view of a single fixed center viewpoint of a celestial body, the surround generator module comprising:
a data shell generator to generate a data shell from the point of view of the center viewpoint based on a determined radial distance from the center viewpoint;
an informational surround generator to generate objects associated with a requested informational surround, each at the determined radial distance from the center viewpoint, for rendering in the generated data shell based on the position of each object relative to the celestial body; and
a surround combination module to generate an informational surround data shell by rendering generated objects, each associated with a requested informational surround, within the generated data shell based on their position relative to the celestial body; and
a user interface module, in communication with the surround generator module, to communicate with users via a user interface device; and
a user interface device in communication with the data processing system to present informational surround data shells to users, comprising:
a surround conversion module to convert a received informational surround data shell into output commands; and
a user output device to present the received informational surround data shell to a user based on the output commands.

32. The system of claim 31, wherein the data processing system and the user interface device are each in different physical devices.

33. The system of claim 31, wherein the data processing system and the user interface device communicate with each other via a wireless communication link.

34. The system of claim 31, wherein the data processing system and the user output device are each in a single physical device.

35. The system of claim 31, wherein the user interface device further comprises a user input device to receive inputs from a user.

36. The system of claim 35, wherein the user input device is one or more of a keyboard, a mouse, a trackball, a joystick, a voice input device, an orientation sensor within a virtual reality input device, an accelerometer, an eye movement sensor, and a virtual reality input device.

37. The system of claim 31, wherein the user output device is one or more of a computer screen, a television, a high definition television (HDTV), a curved concave display, a hemispherical display, a spherical display, a hologram display, a wearable display, and a virtual reality output device.

38. The system of claim 31, wherein the user output device is a set of virtual reality goggles having one or more viewing screen devices.
